(19) United States
(12) Patent Application Publication
(10) Pub. No.: US 2007/0193453 A1
(43) Pub. Date: Aug. 23, 2007

(54) Basting device

(75) Inventors: David A. Holcomb, Seattle, WA (US); Joshua R. Stewart, Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Chef'n Corporation, Seattle, WA (US)

(21) Appl. No.: 11/346,612

(22) Filed: Feb. 2, 2006

(51) Int. Cl. A21B 3/13

(52) U.S. Cl. 99/324

(57) ABSTRACT

A basting device for applying a basting medium to a food comprises an elongated body forming a hollow portion at its distal end and a handle portion toward its proximal end. The device may further include a working portion having a coupling member and a basting member, the coupling member having first and second ends, each end may have an exposed surface adapted to conform to a finger tip of the user. The first end is adapted to removably engage the hollow portion of the elongated body, and the second end is coupled to the basting member. The basting member may include a plurality of concentric bristle members. In other embodiments the basting device may include or be adapted to accommodate a variety of tools. In yet other embodiments, the basting device may include a bulb in fluid communication with the working portion.

### BACKGROUND OF THE INVENTION

1. Field of the Invention

The present invention is generally directed toward cooking tools, and more particularly, to a basting device that is heat resistant and easy to clean.

2. Description of the Related Art

Basting, in a cookery context, describes a process of moistening food, such as different types of meat, while cooking. The basting medium can be melted butter, meat drippings, sauces, or any other liquid or paste that may add color, flavor, or moisture, or any combination thereof to food. Basters are cooking tools typically used to baste food. Numerous types of basters exist, each typically suited for limited applications. For example, basters used for poultry are typically bulb basters having a hollow applicator tube with one end attached to a flexible bulb. To use the bulb baster, a user squeezes the bulb to get the air out of the bulb. Next, the user immerses the open end of the tube in the basting medium and releases the bulb, drawing in the basting medium into the tube. Once the basting medium is in the tube, the user can position the open end of the tube on a desired location on the meat and squeeze the bulb to apply the basting medium to the meat. Yet other basters may not include a bulb or a tube, rather they have a solid stem with a brush at one end. The user immerses the brush in the basting medium and proceeds to spread the basting medium onto the food with the brush.

Despite availability of certain types of basters, improvements remain desired. For example, the bulb basters are capable of taking the basting medium from one place and injecting it elsewhere, without providing means to evenly distribute the medium on food. These basters generally tend to waste a portion of the basting medium due to poor sealing of the bulb. Furthermore, brush basters typically use a conventional brush, which is difficult to clean because of numerous fibers positioned in close proximity to one another. Additionally, the brush fibers typically tend to shed during use, deposited on the food being cooked. Alternatively, brush basters that use silicone brushes to prevent shedding, attempt to emulate the structure of conventional brushes, namely, positioning fibers in a parallel and dense configuration. Some silicone brushes that have widely dispersed brush elements tend to apply the basting medium unevenly because the basting interface of the brush does not conform well to uneven surfaces of food. Other silicone brushes that have silicone fibers closely situated with respect to other fibers continue to exhibit the same cleaning issues as described above in relation to conventional brushes.

Cookery in which basting is desirable typically also involves some other manipulation of the food. For example, barbequing also requires turning over the meat or swapping the location of multiple pieces of food. Traditionally, multiple tools such as a baster and a cooking fork have been used to accomplish these tasks. However, switching between tools hinders the cook's response time to the evolving condition of the meat being cooked.

Additionally, these tools tend to be long to allow the cook to manipulate the food from a sufficient distance to prevent burning of the hands. Furthermore, since generally these tools are rigidly assembled, its parts may not be washed separately. This can be inefficient because typically only the basting interface is stained with the space-consuming portion of the baster remaining clean after use. Inability to disassemble also hinders washing existing basters in a dishwasher due to their size. Rigid assembly also precludes users from replacing only a worn or damaged part of the baster.

Furthermore, recreational cooks are typically involved in some other social activity while they are cooking. For example, it is common to drink beverages while barbequing, especially while basting. In such instances, finding a bottle opener and switching between the baster and the bottle opener can distract the cook from the food being prepared.

Accordingly, there is a need for a basting device that is easy to clean, does not shed its components into food, evenly distributes a basting medium, and includes other kitchen tools.

### BRIEF SUMMARY OF THE INVENTION

In one embodiment, a basting device for applying a basting medium to a food, comprises an elongated body having a hollow portion at its distal end and a handle portion toward its proximal end, the handle portion being adapted to conform to a user's grip and allow the user to manually manipulate the device, and a working portion having a coupling member and a basting member, the coupling member having opposing first and second ends, the first end adapted to removably engage the hollow portion of the elongated body, and the second end being coupled to the basting member.

In another embodiment, a basting device comprises an elongated body forming first and second hollow portions toward its distal and proximal ends, and a handle portion therebetween. The basting device may further include a first working portion having a first coupling member and a basting member, the first coupling member having first and second ends, each end having an exposed surface adapted to conform to a finger tip of the user. The first end can be adapted to removably engage the first hollow portion of the elongated body and the second end can be coupled to the basting member. The basting device may also include a second working portion having a second coupling member and a tool, the second coupling member having an end adapted to removably engage the second hollow portion of the elongated body.

In yet another embodiment, a kit for manipulating and basting foods comprises an elongated body forming a hollow portion at its distal end and a handle portion toward its proximal end, the handle portion being adapted to conform to a user's grip and allow the user to manually manipulate the device. The kit may further comprise a basting member including a coupling member and a plurality of concentric bristle members, the coupling member having first and second ends, each end having an exposed surface adapted to conform to a finger tip of the user. The first end may include a shoulder adapted to removably engage a proximal mouth of the hollow portion of the elongated body and the second end can be coupled to the bristle members. The kit may also comprise a plurality of cooking tools, each having a tool end and a coupling end having a shoulder adapted to removably engage the proximal mouth of the hollow portion.

### BRIEF DESCRIPTION OF THE SEVERAL VIEWS OF THE DRAWING(S)

FIG. 1 is an isometric view of a basting device according to one embodiment of the present invention.

FIG. 2A is a bottom plan view of an elongated body of the basting device of FIG. 1.

FIGS. 2B-2C are cross-sectional views of a handle portion of the basting device of FIG. 1.

FIG. 3 is a top view of a working portion of the basting device of FIG. 1.

FIG. 4 is a side view of the working portion of FIG. 3.

FIG. 5 is a bottom view of a coupling member of the working portion of FIG. 3.

FIG. 6 is a top view of the basting device of FIG. 1.

FIGS. 7A-7B are partial bottom views of the basting device of FIG. 1.

FIG. 8 is a partial bottom view of a basting device according to another embodiment of the present invention.

FIG. 9 is a bottom view of a basting device according to yet another embodiment of the present invention.

FIG. 10 is a side view of a basting device according to still another embodiment of the present invention.

FIG. 11 is a side view of a basting device according to a further embodiment of the present invention.

### DETAILED DESCRIPTION OF THE INVENTION

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Reference throughout this specification to “proximal end” and/or “distal end” are intended to be interpreted with respect to the location of the user when using a device according to an embodiment of the present invention.

Reference throughout this specification to “cooking”, “baking”, “barbequing”, and/or “cookery” is not intended in a limiting sense, but is rather intended to refer to any process involving preparation of food at any temperature.

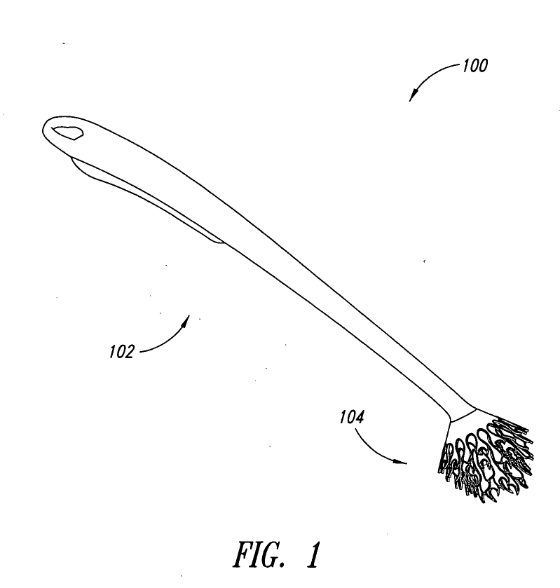

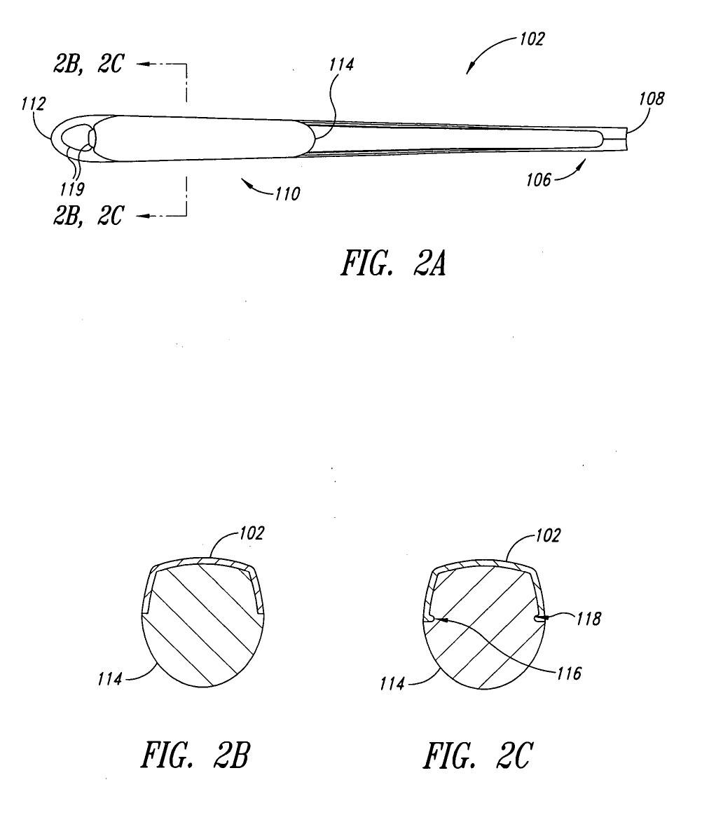

FIG. 1 illustrates a basting device 100 according to one embodiment of the present invention. The basting device 100 comprises an elongated body 102 and a working portion 104. As illustrated in FIG. 2A, the elongated body 102 includes a hollow cylindrical portion 106 toward its distal end 108. The elongated body 102 also includes a handle portion 110 toward its proximal end 112. The handle portion 110 may comprise a part of the elongated body 102 adapted to comfortably conform to a user's grip and allow the user to manually manipulate the basting device 100. The elongated body may be fabricated from natural or synthetic rubbers, metals, composites, temperature resistant plastic or nylon, silicone, or any combination thereof or any other material capable of transferring loads associated with cookery and withstanding temperatures typically experienced while cooking and/or being washed in a dishwasher.

Additionally, or alternatively, the handle portion 110 may include an optional grip member 114 fabricated from a material and in a shape that is comfortable for the user to hold and manipulate the basting device 100. The grip member 114 may be fabricated from natural or synthetic rubbers, metals, composites, plastic or nylon, silicone, or any combination thereof or any other material formable into a shape that is comfortable to hold. In such embodiments, the elongated body 102 may couple to the grip member 114 to form the handle portion 110.

For example, the elongated body 102 may captively receive the grip member 114 as shown in FIG. 2B. The elongated body 102 may couple to the grip member 114 by any suitable coupling or attaching means such as, but not limited to, adhesives, mechanical fasteners, hook and loop fasteners, an interference fit and/or magnets. Additionally, or alternatively, as illustrated in FIG. 2C, the elongated body 102 and the grip member 114 may include a curb 116 and a gutter 118, respectively. In such embodiments, the elongated body 102 can slidably and removably receive the grip member 114, allowing for thorough and easy cleaning of one or both of the elongated body 102 and the grip member 114.

Furthermore, as illustrated in FIG. 2A, the elongated body 102 may include an optional tool 119 toward its proximal end 112. In the illustrated embodiment, the tool 119 is a bottle opener; however those of skill in the art will appreciate that the tool 119 may be a wine-bottle opener, a utensil, a can-puncturing tool or any tool the presence of which may be desirable while using the basting device 100. Therefore, the user may expediently and easily open a beverage bottle or puncture a can containing the basting medium using the tool 119 without having to find a separate tool to accomplish the same and/or to switch to a different tool.

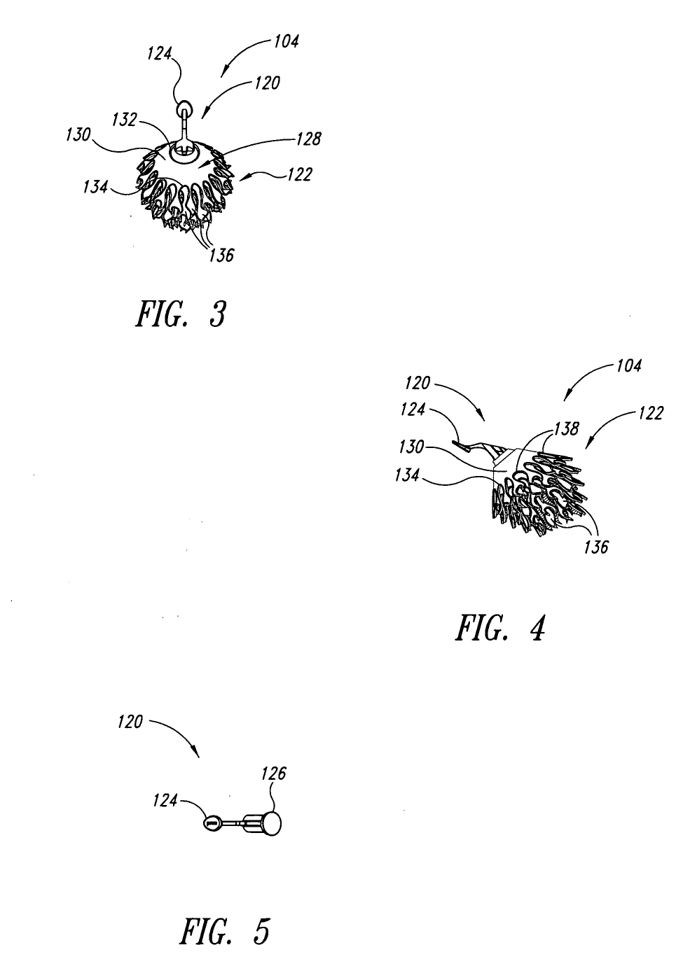

FIGS. 3 and 4 illustrate different views of the working portion 104 in isolation. The working portion 104 includes a coupling member 120 and a basting member 122. FIG. 5 illustrates the coupling member 120 without the working portion 104. The coupling member 120 includes first and second ends 124, 126. The basting member 122 includes a plurality of concentric bristle members 128, each bristle member 128 having a frustoconical portion 130. A narrow base 132 of the frustoconical portion 130 is mounted on the coupling member 120 toward the second end 126 of the coupling member 120. A wider base 134 of the frustoconical portion 130 extends in an outward direction with respect to the coupling member 120, forming a basting interface of the working portion 104.

In the illustrated embodiment of FIGS. 3 and 4, the basting member 122 further includes a plurality of basting extensions 136, extending from the wider base 134 of the frustoconical portion 130. The extensions 136 are spaced and provide additional flexibility at the basting interface of the working portion 104 to promote even distribution of the basting medium on a surface of a food being prepared, which is typically uneven. The basting extensions 136 may extend from at least a portion of a perimeter of the wider base 134. Alternatively, the basting extensions 136 may extend from the entire perimeter of the wider base 134. As illustrated in FIG. 4, a periphery of the basting extensions 136 may include a ridge 138 to better retain the basting medium prior to applying it to the food.

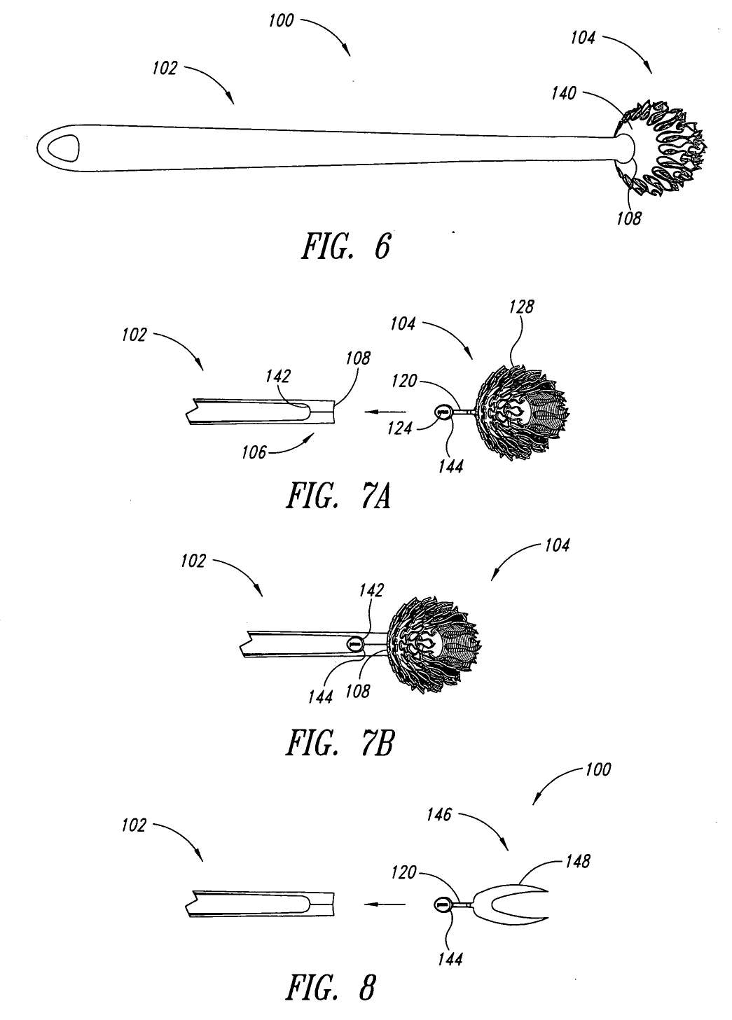

FIG. 6 illustrates a top view of the basting device 100 with the working portion 104 coupled to the elongated body 102. When coupled, the distal end 108 of the elongated body 102 is arranged adjacent an outer bristle member 140 of the working portion 104.

FIGS. 7A and 7B illustrate the coupling member 120 of the working portion 104, coupling the working portion 104 to the hollow cylindrical portion 106 of the elongated body 102. As can be seen in FIG. 7A, the user inserts the coupling member 120 in the-hollow cylindrical portion 106, the coupling member 120 traveling therethrough until the first end 124 of the coupling member 120 reaches a proximal mouth 142 of the hollow cylindrical portion 106. A shoulder 144 of the first end 124 of the coupling member 120 removably engages the proximal mouth 142 of the hollow cylindrical portion 106 when the user applies a force to the second end 126 of the coupling member 120.

Engaging the shoulder 144 to the mouth 142 secures the working portion 104 to the elongated body 102 toward its distal-end 108. The second end 126 of the coupling member 120, toward which the concentric bristle members 128 are mounted, may include an exposed surface adapted to conform to a fingertip of the user. Therefore, the fingertip of the user can be placed on the exposed surface of the second end 126 when the user guides the coupling member 120 through the hollow cylindrical portion 106 to facilitate engagement of the shoulder 144 and the mouth 142.

Next, the user may apply the basting medium to the basting device 100 and manipulate the working portion 104 using the elongated body 102 and/or the handle portion 110 (FIG. 2A). The basting extensions 136 may include curved members forming flame-like shapes, which in addition to providing an aesthetic design, aid in disseminating the basting medium to the uneven surface and hard-to-reach portions of the food, such as chicken, vegetables, whole turkey, or any other food with an uneven surface.

The first end 124 of the coupling member 120 may also include a surface adapted to conform to a fingertip of the user. When the user is finished using the basting device 100, the user may apply a force to this surface to disengage the shoulder 144 from the mouth 142. Subsequently, the user may pull on the working portion 104 to remove the coupling member 120 from the hollow cylindrical portion 106, separating the working portion 104 from the elongated body 102. Therefore, the user may separately clean the working portion 104. When using the basting device 100 for applications in which the elongated body 102 may not require washing, the user may only wash the working portion 104. Additionally, or alternatively, upon damage or wear to the working portion 104, the user may simply replace the working portion 104 instead of replacing the entire basting device 100.

Those of skill in the art can appreciate that the coupling member 120 can accommodate any tool for baking, cooking and/or barbequing. For example, in another embodiment of the present invention as shown in FIG. 8, the basting device 100 may include a working portion 146 having a fork 148 mounted on the coupling member 120. It is understood that a kit may be provided that includes the elongated body 102 and at least two working portions 104 (FIG. 7A), 146, each of which include a distinct cooking tool such as the basting member 122 (FIG. 7A) and the fork 148. For example a kit including the elongated body 102, the basting member 122 and the fork 146 allows a user to easily switch between the working portions 104,146 by disengaging and engaging the coupling member 120 as discussed herein. This is especially desirable in applications, simultaneously requiring basting and manipulating such as barbequing. In the barbequing context, the user may baste the food using the basting member 122 (FIG. 3) and manipulate the food using the same elongated body 102 and the fork 148.

FIG. 9 illustrates yet another embodiment, in which a basting device 200 includes an elongated body 202 having a handle portion 210 and first and second hollow cylindrical portions 206, 207 respectively positioned toward opposing ends of the elongated body 202. The hollow cylindrical portions 206, 207 are adapted to couple to the coupling members 120. The coupling members 220 may respectively carry a basting member 222 and a fork 246. Therefore, the basting device 200 can accommodate the two working portions 204, 246 at its opposing ends. The handle portion 210 may include an optional grip member 214, the configuration of which may be substantially similar to that discussed in conjunction with other embodiments.

In this embodiment, the basting device 200 may be suitable for applications such as those in which further expediting the duration of switching between tools is critical to the cooking process. For example, when barbequing a large quantity of food pieces, each piece entering the grill at a different time and/or requiring manipulation at different time intervals, the user is required to manipulate the pieces in a staggered pattern, resulting in frequent manipulation of the food. Therefore, the user may use the basting member 222 to apply the basting medium to the food while being capable of instantly rotating the basting device 200 to use the fork 248 to manipulate the food. Upon completion of the cooking process, the user may separate both working portions 204, 246 to separately and/or solely wash the working portions 204, 246.

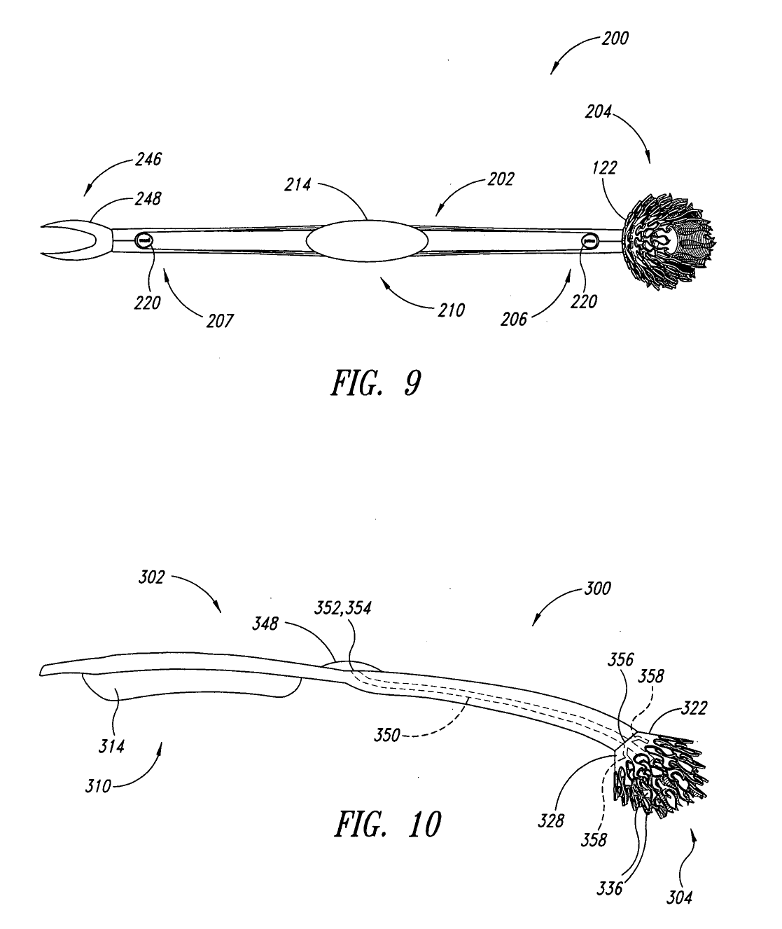

FIG. 10 illustrates still another embodiment, in which a basting device 300 includes an elongated body 302 coupled to a working portion 304 having a basting member 322. The basting device 300 also includes a handle portion 310, which may include the grip member 314. The basting member 322 includes a plurality of concentric bristle members 328, which may optionally include a plurality of basting extensions 336. Additionally, the basting device 300 includes a bulb 348 in fluid communication with the working portion 304 via a cylindrical hollow 350, longitudinally formed or retained in the elongated body 302. A first end 352 of the cylindrical hollow 350 sealingly coincides with a gate 354 on a surface of the bulb 348. A second end 356 of the cylindrical hollow 350 includes at least one outlet 358 at least partially extending adjacent the bristle members 328.

The bulb 348 can be positioned on a top portion of the elongated body 302, proximate the handle portion 310 to allow the user to conveniently operate the bulb 348 with a finger, such as a thumb, while gripping the elongated body 302 at the handle portion 310. In operation, the working portion 304 of the basting device 300 may be at least partially immersed in the basting medium. Preceding or subsequent to the immersion, the user may depress the bulb 348, forcing fluids out of the cylindrical hollow 350. Upon immersion, the user may release the bulb 348, drawing the basting medium into the cylindrical hollow 350 and/or the bulb 348 through the at least one outlet 358. The user may next position the working portion 304 over and/or on the food or a portion thereof, and selectively apply the basting medium to the food by depressing the bulb 348. Upon application of the basting medium to the food, the user may manipulate the bristle members 328 to disseminate the basting medium onto uneven surfaces of the food.

In the embodiment illustrated in FIG. 10, the basting device 300 includes a plurality of outlets 358 that extend between the concentric bristle members 328 of the basting member 322. In contrast to conventional bulb basters in which a large amount of basting medium is dispensed from one outlet, this embodiment of the basting device 300 evenly distributes the basting medium to the bristle members 328 and/or the food, the basting medium being thereafter manipulable by the bristle members 328.

The bulb 348 may be fabricated from a resilient material such as synthetic rubbers, composites, plastic or nylon, silicone, or any combination thereof or any other material capable of deforming from a first shape to a second shape upon application of a pressure and resuming the first shape upon release of the pressure. The cylindrical hollow 350 may include a tube made from a flexible and/or resilient material that extends from the gate 354 of the bulb 348 to beyond the second end 356 of the cylindrical hollow 350 and branches out into the at least one outlet 358. Alternatively, the at least one outlet 358 may be mounted on a tubular base that is removably and sealingly received in the second end 356 of the cylindrical hollow 350.

An individual of skill in the art will appreciate these and other modifications that can be made to the basting device 300 without deviating from the spirit of the invention. For example, the bulb 348 may be positioned on a side or a bottom portion of the elongated body 102. Additionally, or alternatively, the bulb 348 may be incorporated in a portion of the handle portion 310. Furthermore, the bulb 348 can include a receptacle portion formed in a top surface of the elongated body 302, which removably and sealingly receives a resilient cap portion. Therefore, a user may also remove at least a portion of the bulb 348 to thoroughly clean the interior of the bulb 348.

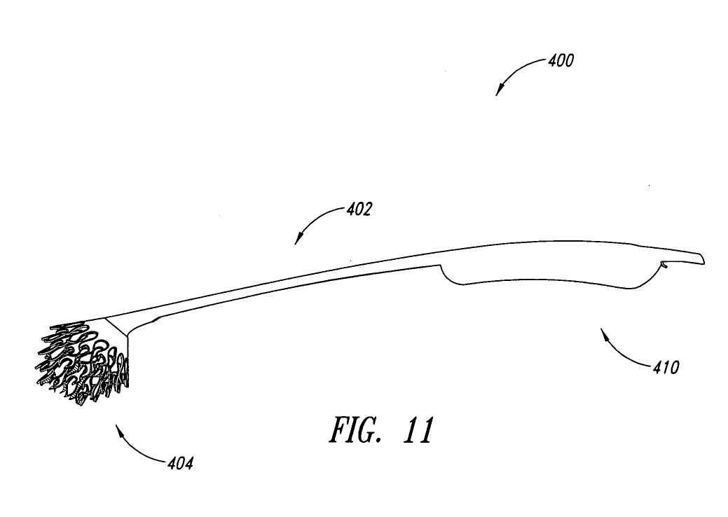

FIG. 11 illustrates a further embodiment of a basting device 400 in which an elongated body 402, a working portion 404, and a handle portion 410 are fabricated from a unitary body of material such as silicone. Alternatively, the elongated body 402 and the handle portion 410 may be integrated and the working portion 404 may be separate and include a coupling member that couples the working portion 404 to the elongated body 402 as described in conjunction with other embodiments.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A basting device for applying a basting medium to a food, the basting device comprising:
an elongated body having a hollow portion at its distal end and a handle portion toward its proximal end, the handle portion being adapted to conform to a user's grip and allow the user to manually manipulate the device; and
a working portion having a coupling member and a basting member, the coupling member having opposing first and second ends, the first end adapted to removably engage the hollow portion of the elongated body, and the second end being coupled to the basting member.

2. The basting device of claim 1, wherein the basting member includes a frustoconical portion, a narrow base of the frustoconical portion being mounted on the coupling member toward the second end of the coupling member, and a wider base of the frustoconical portion extending in an outward direction with respect to the elongated body and forming a basting interface of the working portion.

3. The basting device of claim 2, wherein the narrow base of the frustoconical portion of the basting member is sealingly arranged adjacent the distal end of the elongated body upon engagement of the coupling member and the hollow portion, precluding the basting medium from entering the hollow portion.

4. The basting device of claim 2, wherein the basting interface further comprises a plurality of basting extensions extending from the wider base of the frustoconical portion.

5. The basting device of claim 4, wherein the plurality of basting extensions include at least one ridge along at least a portion of a periphery of the basting extensions to promote retention of the basting medium prior to application of the basting medium to the food.

6. The basting device of claim 1, wherein the handle portion further comprises a grip member and the elongated body captively receives at least a portion of the grip member toward the proximal end of the elongated body.

7. The basting device of claim 6, wherein the elongated body and the grip member are fabricated from a unitary body of material.

8. The basting device of claim 1, wherein at least one of the elongated body and the working portion is made from a resilient heat resistant material.

9. The basting device of claim 1, wherein the engagement of the coupling member and the hollow portion is facilitated by a force exerted on the second end of the coupling member, removably engaging a shoulder on the first end of the coupling member against a proximal mouth of the hollow portion and securing the working portion toward the distal end of the elongated body.

10. The basting device of claim 9, wherein disengagement of the coupling member and the hollow portion is facilitated by a force exerted on the first end of the coupling member, disengaging the shoulder of the coupling member from the mouth of the hollow portion and separating the working portion from the elongated body.

11. The basting device of claim 1, further comprising a kitchen tool formed toward the proximal end of the elongated body.

12. The basting device of claim 11, wherein the kitchen tool is a bottle opener.

13. The basting device of claim 11, wherein the kitchen tool is a cooking utensil.

14. The basting device of claim 1, further comprising a bulb in fluid communication with the basting member and operable to draw the basting medium from an external supply.

15. The basting device of claim 14, further comprising a hollow portion having first and second ends, the first end sealingly coinciding with an opening on a surface of the bulb and the second end removably and sealingly coupled to at least one outlet operable to disseminate the basting medium on the basting member.

16. A basting device, comprising:
an elongated body forming first and second hollow portions toward its distal and proximal ends, and a handle portion therebetween;
a first working portion having a first coupling member and a basting member, the first coupling member having first and second ends, each end having an exposed surface adapted to conform to a finger tip of the user, the first end adapted to removably engage the first hollow portion of the elongated body, the second end coupled to the basting member; and
a second working portion having a second coupling member and a tool, the second coupling member having an end adapted to removably engage the second hollow portion of the elongated body.

17. A kit for manipulating and basting foods, the kit comprising:
an elongated body forming a hollow portion at its distal end and a handle portion toward its proximal end, the handle portion being adapted to conform to a user's grip and allow the user to manually manipulate the device;
a basting member including a coupling member and a plurality of concentric bristle members, the coupling member having first and second ends, each end having an exposed surface adapted to conform to a finger tip of the user, the first end having a shoulder adapted to removably engage a proximal mouth of the hollow portion of the elongated body, the second end being coupled to the bristle members; and
a plurality of cooking tools, each having a tool end and a coupling end having a shoulder adapted to removably engage the proximal mouth of the hollow portion.
